(19) United States
(12) Patent Application Publication
(10) Pub. No.: US 2018/0015382 A1
(43) Pub. Date: Jan. 18, 2018

(54) AN ERASER AND A TOY BUILDING SET WITH AN ERASER

(71) Applicant: LEGO A/S, Billund (DK)

(72) Inventor: Arnaud DUBREUIL, Vejle (DK)

(21) Appl. No.: 15/540,429

(22) PCT Filed: Jan. 13, 2016
(86) PCT No.: PCT/EP2016/050547

§ 371 Date: Jun. 28, 2017

(30) Foreign Application Priority Data
Jan. 13, 2015 (DK) PA201570013

(51) Int. Cl. A63H 33/06; B43L 19/00; A63H 33/08

(52) U.S. Cl. CPC A63H 33/065; A63H 33/086; B43L 19/0068

(57) ABSTRACT

An eraser comprising an eraser part 1 made from a relatively elastic material having eraser properties, and where the eraser further comprises a connector part 4 made from a relatively firm material, and wherein the connector part 4 has a first connection surface 8 provided with one or more first coupling parts 7 configured for interconnection with another element, and where said connector part 4 is embedded in a cavity 2 arranged in the eraser part 1 in such a way that said first connection surface 8 faces away from said cavity 2.

### FIELD OF USE OF THE INVENTION

The present invention relates to an eraser made from a relatively resilient material having eraser properties allowing it to be used for erasing e.g. pencil or ink markings on a piece of paper.

### STATE OF THE ART

Erasers of the above mentioned kind have been known for many years in a lot of different embodiments, and as erasers are often used by children it is very common to design the erasers so that they can be used both as an eraser as well as a toy or in connection with other toys.

Examples of such prior erasers are erasers shaped as, or embedded in toys such as toy animals, flowers and building blocks.

### OBJECT OF THE INVENTION

On this background it is the object of the present invention to propose an eraser providing improved functionality bot as an eraser and as a toy building element.

According to the invention this is obtained by an eraser further comprising a connector part made from a relatively firm material, and wherein the connector part has a first connection surface provided with one or more first coupling parts configured for interconnection with another element, and is mounted in a cavity arranged in the eraser part to form a channel extending through the eraser in such a way that said first connection surface faces away from said cavity.

In this way the connector part can be made from a material that keeps its coupling characteristics because it does not wear out when the eraser is used for erasing, and at the same time enabling that a major portion of the eraser part can be shaped in many different ways and thereby be used for different purposes in a toy building set.

Furthermore the connector part forms a firm grip for the user.

In a preferred embodiment the cavity forms a channel extending completely through the eraser part.

In this relation the connector part advantageously has a second connection surface provided with one or more second coupling parts configured for interconnection with another element, and each of the first and the second coupling parts are configured for interconnection with coupling parts being identical to the other of the first or the second coupling parts respectively.

In a further preferred embodiment the channel is straight, and the first and the second connection surfaces are facing in opposite directions away from the channel. This provides an easy assembly of the eraser part and the connector part and at the same time provides the option of stacking two or more such erasers.

In this relation the first coupling parts may comprise one or more coupling knobs extending away from the first connection surface, and the second coupling parts may comprise one or more coupling cavities arranged in the second connection surface.

In an especially simple embodiment the channel extends in the eraser part with a uniform cross section so that it is possible to just slide the connector part into the channel, e.g. with a press fit.

In this relation the uniform cross section of the channel and/or the corresponding cross section of the connector part may preferably be circular cylindrical, so as to avoid cracking of the eraser part.

Alternatively the uniform cross section of the channel and the connector part may be non circular and preferably square in order to avoid that the eraser part rotates about the connector part.

According to the invention the eraser is very useful as an eraser due to the fact that major parts of the surface of the eraser part are free.

The eraser may advantageously be used as a building element in a toy building set comprising another element having one or more coupling parts configured for interconnection with said first coupling parts on the connector part.

### LIST OF FIGURES

FIG. 1 is an exploded perspective drawing of an eraser according to the invention.

FIG. 2 is a perspective drawing of the eraser shown in FIG. 1 in an assembled condition.

FIG. 3 is a side view of the assembly shown in FIG. 2.

FIG. 4 is a side view of the assembly shown in FIG. 2 mounted on another building block.

FIG. 5 is an exploded perspective drawing of an alternative embodiment of an eraser according to the invention.

FIG. 6 is a perspective drawing of the eraser shown in FIG. 5 in an assembled condition.

### EMBODIMENT OF THE INVENTION

Thus, FIG. 1 shows an eraser according to the invention having an eraser part 1 made from an elastic material suitable for erasing e.g. Pencil or ink marks on a piece of paper. As materials of this kind are well known in many different compositions and colours optimized for specific purposes, then it will be apparent to the skilled person that any such material may be used in relation to this invention.

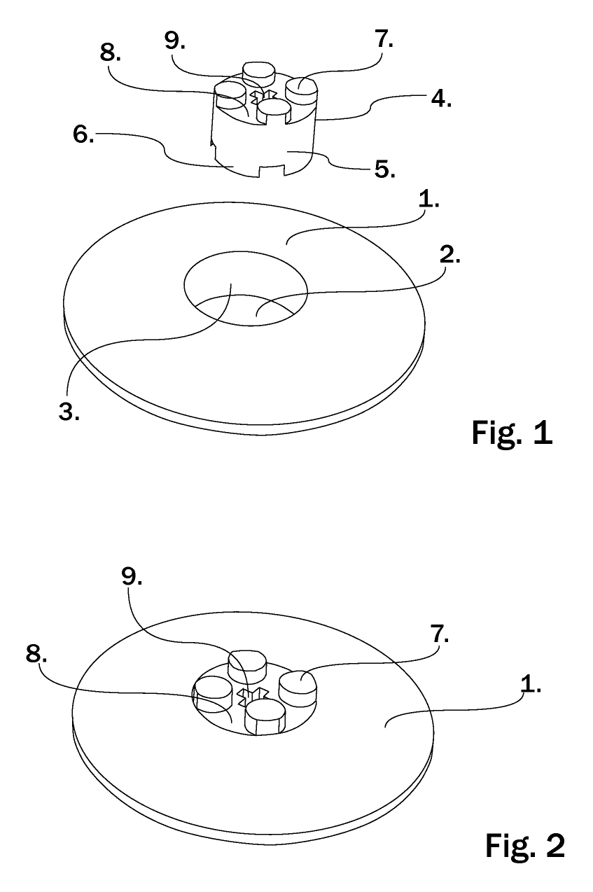

A cavity formed by the through hole 2 has a circular cylindrical surface 3 formed in the eraser part 1 in order to provide a space for insertion of a connector part in the form of a toy building block 4 from a toy construction set. In this embodiment the building block 4 has a circular cylindrical outer surface 5 with a cross section being slightly larger than the cross section of the hole 2, and it is made from a relatively firm material than the material forming the eraser part 1. In this way the building block 4, when inserted into the through hole 2, will elastically stretch the eraser part 1 so that the building block 4 is efficiently locked in its position in the through hole by friction such as shown in FIG. 2.

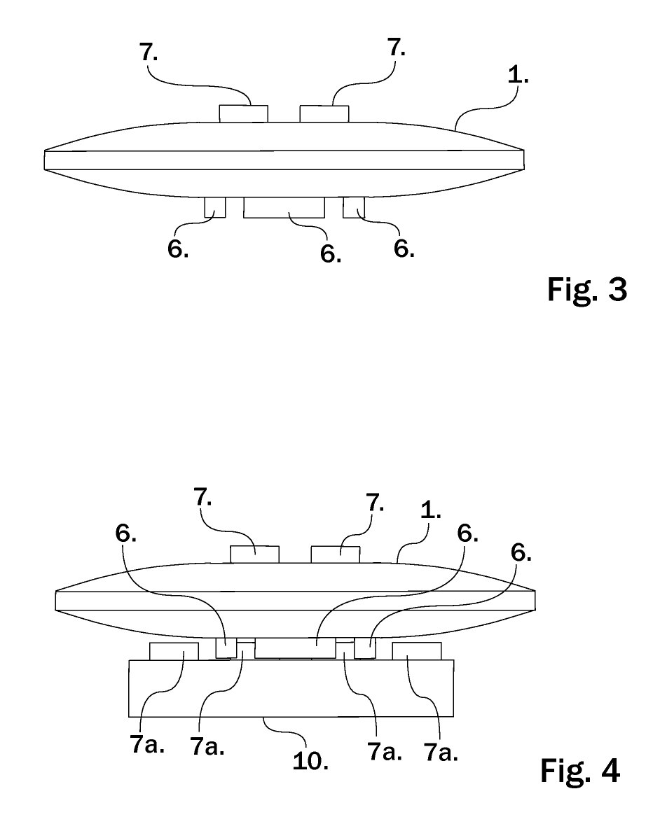

The building block 4 has a connection surface 8 with first coupling parts formed by four coupling knobs 7. In the inserted position of the building block 4 the connection surface 8 can be positioned so that it flushes with the upper surface of the eraser part 1, and so that the couplings knobs extends above the upper surface of the eraser part. In this position the second coupling parts formed by coupling skirts 6 extends below the lower surface of the eraser part 1 as shown on FIGS. 3 and 4 so that the assembled eraser may be stacked upon another identical eraser (not shown in the drawings) so that the coupling knobs 7 of one eraser engages with the couplings skirts 6 of the other.

Alternatively the eraser may, as shown on FIG. 4, be mounted on top of another building block 10 having a number of coupling knobs 7a on one side, an likewise a third building block (not shown) may be positioned on top of the eraser shown in FIG. 4 so that it is possible to use the eraser may be fixed in a construction made from different building blocks from a toy building set.

Although some embodiments have been described and shown in detail, the invention is not restricted to them, but may also be embodied in other ways within the scope of the subject matter defined in the following claims. In particular, it is to be understood that other embodiments may be utilized and structural and functional modifications may be made without departing from the scope of the present invention.

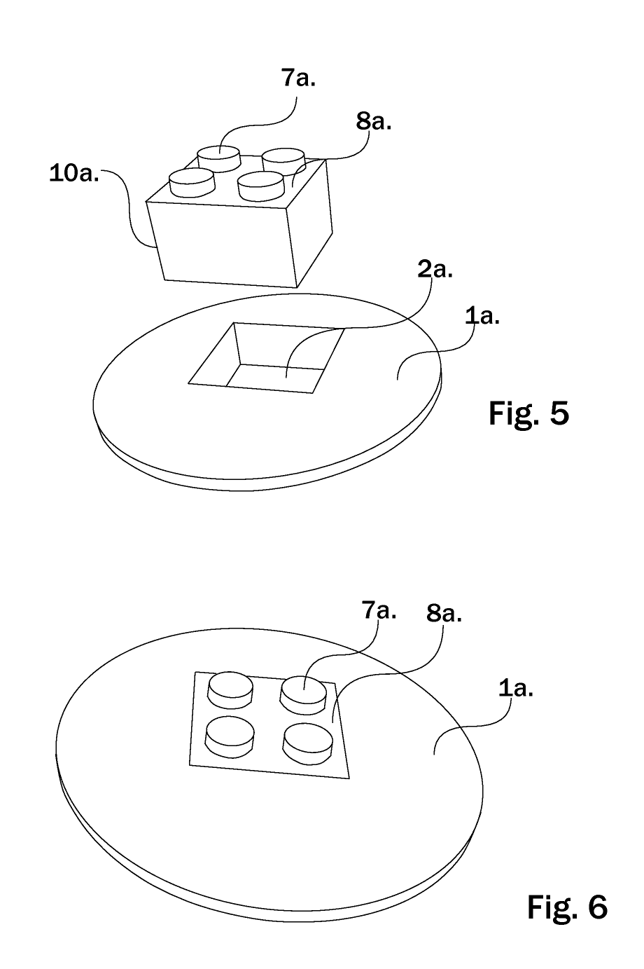

As an example FIGS. 5 and 6 shows an alternative embodiment where the connector part/building block 10a, in order to avoid the eraser part 1a rotates about the building block 10a, has a square connection surface 8a and correspondingly a square cross section to be inserted into the through hole/channel 2a having a cross section with a slightly smaller side length that then side length of the square cross section of the building block 10a.

In device claims enumerating several features, several of these features can be embodied by one and the same item of hardware. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, integers, steps or components but does not preclude the presence or addition of one or more other features, integers, steps, components or groups thereof.

1. An eraser comprising:
an eraser part made from a relatively resilient material having eraser properties, characterized in, that the eraser further comprises a connector part made from a relatively firm material, and wherein the connector part has a first connection surface provided with one or more first coupling parts configured for interconnection with another element, and where said connector part is embedded in a cavity forming a channel extending completely through the eraser part, and in such a way that said first connection surface faces away from said cavity.

2. An eraser according to claim 2, characterized in, that the connector part has a second connection surface provided with one or more second coupling parts configured for interconnection with another element, and where each of the first and the second coupling parts are configured for interconnection with coupling parts being identical to the other of the first or the second coupling parts respectively.

3. An eraser according to claim 3, characterized in, that the channel is straight, and the first and the second connection surfaces are facing in opposite directions.

4. An eraser according to claim 4, characterized in, that the first coupling parts comprises one or more coupling knobs extending away from the first connection surface, and in that the second coupling parts comprises one or more coupling cavities arranged in the second connection surface.

5. An eraser according to claim 4 or 5, characterized in, that the channel extends in the eraser part with a uniform cross section.

6. An eraser according to claim 6, characterized in, that the uniform cross section of the channel is circular, and that the connector part is shaped so that the eraser part is deformed when the connector part is inserted into the channel.

7. An eraser according to claim 7, characterized in, that the connector part has a circular cylindrical surface between the first and the second connection surface and a diameter being slightly larger than the corresponding diameter of the circular cross section of the channel.

8. An eraser according to claim 6, characterized in, that the uniform cross section of the channel is non circular, and that the connector part is shaped so that the eraser part is deformed when the connector part is inserted into the channel.

9. An eraser according to claim 9, characterized in, that the uniform cross section of the channel is square, and that the corresponding cross section of the connector part is also square with a side length being slightly larger than the side length of the cross section of the channel.

10. The use of an eraser according to one or more of the preceding claims as an eraser.

11. A toy building set comprising an eraser according to one or more of claims 1 to 8, and further comprising another element having one or more coupling parts configures for interconnection with said first coupling parts on the connector part.
